(19) United States
(12) Patent Application Publication
(10) Pub. No.: US 2016/0071161 A1
(43) Pub. Date: Mar. 10, 2016

(54) Systems and Methods for Identifying a Target Audience in a Social Data Network

(71) Applicant: Sysomos L.P., Toronto (CA)

(72) Inventors: Edward Dong-Jin KIM, Toronto (CA); Kanchana PADMANABHAN, Toronto (CA)

(73) Assignee: SYSOMOS L.P., Toronto (CA)

(21) Appl. No.: 14/848,985

(22) Filed: Sep. 9, 2015

Related U.S. Application Data
(60) Provisional application No. 62/048,612, filed on Sep. 10, 2014.

(51) Int. Cl. G06Q 30/02; G06F 17/30; G06Q 50/00

(52) U.S. Cl. CPC G06Q 30/0269; G06Q 50/01; G06F 17/3089

(57) ABSTRACT

System and methods performed by a server for determining a target group of users in a social data network, including: obtaining identities of friends from an initial group of users, where a user in the group follows one or more of the friends; determining N number friends that are most frequently occurring amongst the identities of friends from the initial group; for each of the N number friends, obtaining identities of followers following a given one of the N friends; filtering out one or more followers from the identities of the followers that follow less than X number of the N number of friends, where X≦N; and including remaining ones of the identities of the followers in the target group of users

### CROSS-REFERENCE TO RELATED APPLICATIONS:

This application claims priority to U.S. Provisional Patent Application No. 62/048,612 filed on Sep. 10, 2014, titled “Systems and Methods for Identifying a Target Audience in a Social Data Network”, the entire contents of which are herein incorporated by reference.

### TECHNICAL FIELD

The following generally relates to analysing social network data.

### BACKGROUND

In recent years social media has become a popular way for individuals and consumers to interact online (e.g. on the Internet). Social media also affects the way businesses aim to interact with their customers, fans, and potential customers online.

Some users on particular topics with a wide following are identified and are used to endorse or sponsor specific products. For example, advertisement space on a popular blogger's website is used to advertise related products and services.

Social network platforms are also used to communicate with a targeted group of people, or advertise to a targeted group of people. Examples of social network platforms include those known by the trade names Facebook, Twitter, LinkedIn, Tumblr, and Pinterest. Quickly and accurately identifying relevant target groups becomes more difficult when the number of users within a social network grows.

### BRIEF DESCRIPTION OF THE DRAWINGS

Embodiments will now be described by way of example only with reference to the appended drawings wherein:

FIG. 1 is a flow diagram of an example embodiment for identifying a target group of users and communicating to the same.

FIG. 2 is a diagram illustrating users in connection with each other in a social data network.

FIG. 3 is a schematic diagram of a server in communication with a computing device.

FIG. 4 is a flow diagram of an example embodiment of computer executable instructions for identifying a target audience.

FIG. 5 is a diagram illustrating high-authority users and low-authority users in connection with each other in a social data network.

FIG. 6 is a flow diagram of another example embodiment of computer executable instructions for determining a target audience including users related to high-authority users and users related to low-authority users.

### DETAILED DESCRIPTION OF THE DRAWINGS

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Social networking platforms include users who generate and post content for others to see, hear, etc (e.g. via a network of computing devices communicating through websites associated with the social networking platform). Non-limiting examples of social networking platforms are Facebook, Twitter, LinkedIn, Pinterest, Tumblr, blogospheres, websites, collaborative wikis, online newsgroups, online forums, emails, and instant messaging services. Currently known and future known social networking platforms may be used with principles described herein. Social networking platforms can be used to market to, and advertise to, users of the platforms. It is recognized that although computers currently track data related to users, current computing systems have difficulty identifying a relevant target audience.

Although the principles described herein may apply to different social networking platforms, many of the examples are described with respect to Twitter to aid in the explanation of the principles.

It also recognized that social networks offer enormous potential for brands and companies to a target audience in a way that is scalable, quick, and independent of a topic.

A known computing approach to identify a target group or a target audience is to segment people or users into granular cohorts. Computers are currently used to identify these groups or segments of people based on common interests obtained by analysing tags and metadata. For example, computers periodically examine the content of the messages from the users, or other text associated with the users to determine the interests of each user. In turn, these interests are used to group users. It is recognized that this process can be data intensive, and typically requires time to examine the interests. It also recognized that this computing process is typically specific to a topic. For example, for each topic, a computer system will need to perform a new analysis of interests of the users in order to identify interests related to the topic. It is also recognized that the content of a user's messages changes over time, and thus, the analytics of interests may be outdated if the latest content of a user has not been analyzed. It is also recognized the above computing process is difficult to scale when there are millions of users continuously generating data content.

In an example aspect of the proposed computing systems and methods, an approach is provided to identifying a target audience, which is based on identifying friends (e.g. relationships between data accounts). Consider an old Mexican proverb that says, “Tell me who your friends are and I'll tell you who you are”. This is hugely fitting in today's online social data networks.

People active on social networks “friend” people/organizations they like, they re-tweets posts of people whose opinion matter's to them, and they click on links on topics they enjoy from trustworthy sources.

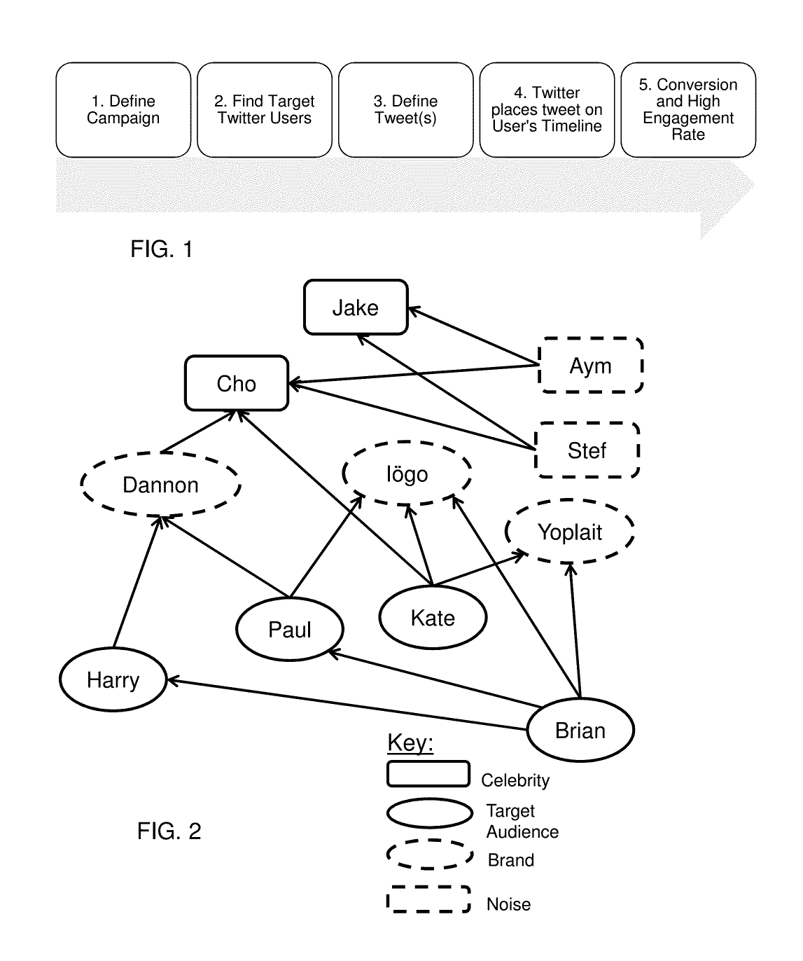

This new social way of thinking has significant implications in advertising. For example, brand building Twitter's “Tailored Audience” is designed to take advantage of this social reality, allowing brands to reach out to their target audience (see FIG. 1). FIG. 1 provides a simplified overview of the steps needed to reach the intended audience on Twitter. The goal is to get a lot of conversions and a high engagement rate. A conversion on Twitter is clicking on the link that's in the tweet. Engagement rate typically includes re-tweets, favorites, and replies. Other social data network platforms may have similar approaches to finding a target audience or a tailored audience.

The success of “Tailored Audience” hugely depends on finding the right targets.

It is herein recognized, however, that a computing system that leverages the social data network structure, including the friend and follower relationships, may be used to accurately identify relevant target audiences.

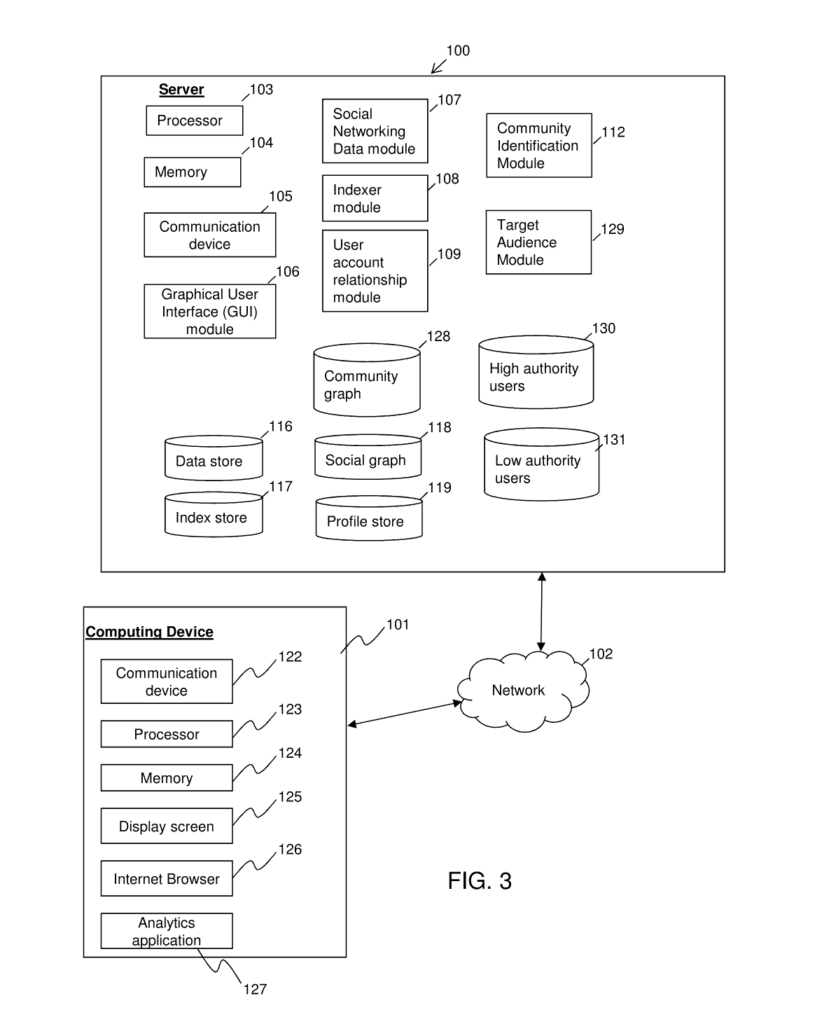

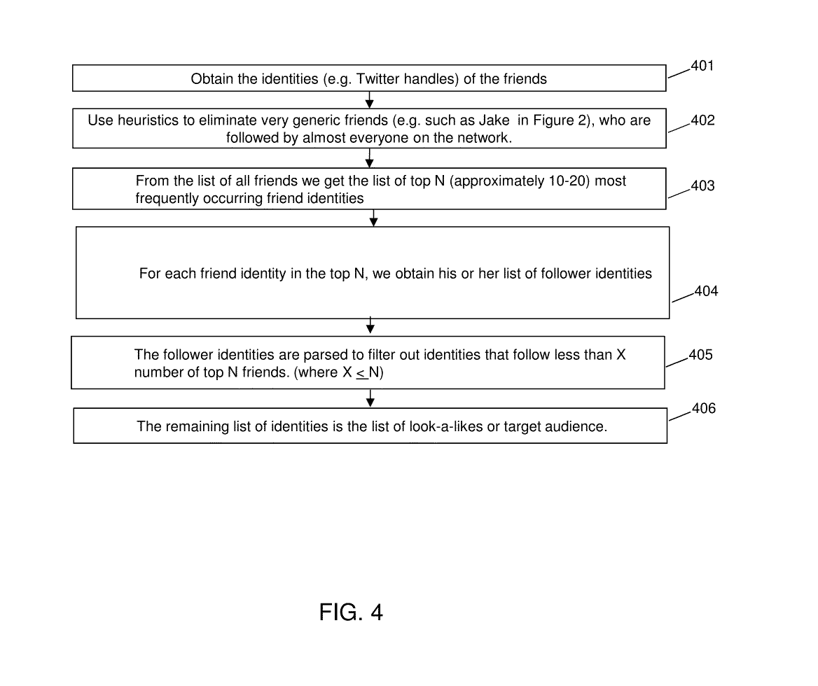

A non-limiting motivating example is shown in FIG. 2. The brand Dannon is a consumer goods company and they want to launch a campaign for their latest yogurt. There are other yogurt brands on the market such as brand Iögo and brand YoPlait. Celebrity Cho endorses many products of brand Dannon including this yogurt. We also know that Paul and Harry are all loyal customers of the brand. FIG. 1, shows their makeup on a social network. There is also Celebrity Jake who has the most number of followers on the network.

FIG. 2 shows an example social network. The target audiences for a brand Dannon are Harry, and Paul who follow Dannon, Kate who follows Cho (the brand ambassador of Danon) and another similar brand Iögo, and Brian who follows similar brands and brand Dannon's loyalists. However, other people such as Aym and Stef who follow a lot of the celebrities are likely not part of target audience.

From the graph, we get the sense that Kate and Brian are similar to Harry and Paul since they follow other yogurt brands such as Iögo, and Yoplait. Additionally, they both follow Dannon's brand ambassador Cho. Similarly, if Iögo, and Yoplait have other followers, they would also be target audience. However, Ayman and Stef and many others follow Jake and Cho but have no predisposition towards Dannon or Dannon like brands are likely not part of the target audience.

In many cases, the brand can identify a few Harrys, Pauls and Yoplaits. One of the challenges for a computing system lies in using this information and the social network structure to identify other people like Harry or Paul who like Dannon or people like Brian who are followers of similar brands like Yoplait.

It is herein recognized that, given a small list of users that have some significance for the brand, the followers of high authority handles (e.g., Yoplait or Iögo) are part of the target audience. For the low authority handles, the followers of their friends are part of the target audience (e.g., given Paul, Iögo is Paul's friend, and Kate is Iögo's follower; Kate is part of target audience).

The proposed computing systems and methods provided herein may be used to exploit the social network structure to provide the power to expand lists of, for example, 1,000 users to millions of users in one or more target audiences.

More generally, social networks allow users to easily pass on information to all their followers (e.g., re-tweet or @reply using Twitter) or friends (e.g., share using Facebook).

The terms “friend” and “follower” are defined below.

The term “follower”, as used herein, refers to a first user account (e.g. the first user account associated with one or more social networking platforms accessed via a computing device) that follows a second user account (e.g. the second user account associated with at least one of the social networking platforms of the first user account and accessed via a computing device), such that content posted by the second user account is published for the first user account to read, consume, etc. For example, when a first user follows a second user, the first user (i.e. the follower) will receive content posted by the second user. In some cases, a follower engages with the content posted by the other user (e.g. by sharing or reposting the content). The second user account is the “followee” and the follower follows the followee.

It will be appreciated that a user account is a known term in the art of computing. In some cases, although not necessarily, a user account is associated with an email address. A user has a user account and is identified to the computing system by a username (or user name). Other terms for username include login name, screen name (or screenname), nickname (or nick) and handle.

A “friend”, as used herein, is used interchangeably with a “followee”. In other words, a friend refers to a user account, for which another user account can follow. Put another way, a follower follows a friend.

A “social data network” or “social network”, as used herein includes one or more social data networks based on different social networking platforms. For example, a social network based on a first social networking platform and a social network based on a second social networking platform may be combined to generate a combined social data network. A target audience of users may be identified using the combined social data network, or also simply herein referred to as a “social data network” or “social network”.

For example, regarding friends, in FIG. 2 Harry, Paul, and Yoplait are friends of Brian. Brian can get updates and direct messages (e.g. posts) from any one of them. Regarding followers, in FIG. 2, Harry and Paul are Dannon's followers. Dannon can choose to send direct messages or posts to Harry and Paul; however, the reverse (solely based on FIG. 2) may not be true.

The term “post” or “posting” refers to content that is shared with others via social data networking. A post or posting may be transmitted by submitting content on to a server or website or network for other to access. A post or posting may also be transmitted as a message between two computing devices. A post or posting includes sending a message, an email, placing a comment on a website, placing content on a blog, posting content on a video sharing network, and placing content on a networking application. Forms of posts include text, images, video, audio and combinations thereof. Twitter refers to posts as “tweets”.

The term “authority” refers to a metric computed using an algebraic formula incorporating the number of followers and the number of mentions (e.g. Tweets, posts). This metric, sometimes called the “authority metric” or “authority score”, provides a rough estimate to distinguish between the more influential users, such as popular users and brand or company accounts, (e.g. Yoplait) and other users (e.g. Harry). The users with higher authority scores (e.g., Yoplait, Iögo, and Cho) will likely be other similar brands or brand influencers and hence their followers are the target audience. The users with low authority (e.g., Harry, Paul, and Brian) are themselves the target audience. The input users will be segregated based on authority and treated differently in the methodology.

In an example embodiment, the Authority score, for example, is computed using a linear combination of several parameters, including the number of posts from a user and the number followers that follow the same user. In an example embodiment, the linear combination may also be based on the number of ancillary users that the same user follows.

The Authority score has a high follower count bias. If there is a well-defined specialist in a certain field with a limited number of followers, but all of them are also experts, they will never show up in the top 20 to 100 results due to their low follower count. Effectively, all the followers are treated as having equal weight.

Other methods and processes may be used to rank the users. For example, the server may use PageRank to measure importance of a user within the topic network and to rank the user based on the measure. Other non-limiting examples of ranking algorithms that can be used include: Eigenvector Centrality, Weighted Degree, Betweenness, Hub and Authority metrics.

Turning to FIG. 3, a schematic diagram of a proposed computing system is shown. A server 100 is in communication with a computing device 101 over a network 102. The server 100 obtains and analyzes social network data and provides results to the computing device 101 over the network. The computing device 101 can receive user inputs through a GUI to control parameters for the analysis.

It can be appreciated that social network data includes data about the users of the social network platform, as well as the content generated or organized, or both, by the users. Non-limiting examples of social network data includes the user account ID or user name, a description of the user or user account, the messages or other data posted by the user, connections between the user and other users, location information, etc. An example of connections is a “user list”, also herein called “list”, which includes a name of the list, a description of the list, and one or more other users which the given user follows. The user list is, for example, created by the given user.

Continuing with FIG. 3, the server 100 includes a processor 103 and a memory device 104. In an example embodiment, the server includes one or more processors and a large amount of memory capacity. In another example embodiment, the memory device 104 or memory devices are solid state drives for increased read/write performance. In another example embodiment, multiple servers are used to implement the methods described herein. In other words, in an example embodiment, the server 100 refers to a server system. In another example embodiment, other currently known computing hardware or future known computing hardware is used, or both.

The server 100 also includes a communication device 105 to communicate via the network 102. The network 102 may be a wired or wireless network, or both. The server 100 also includes a GUI module 106 for displaying and receiving data via the computing device 101. The server also includes: a social networking data module 107; an indexer module 108; a user account relationship module 109; a community identification module 112 and a target audience module 129. As will be described, the community identification module 112 is configured to define communities or cluster of data based on a network graph.

The server 100 also includes a number of databases, including a data store 116, an index store 117, a database for a social graph 118, a profile store 119, a database for storing community graph information 128, a database for storing high-authority users 130, and a database for storing low-authority users 131.

The social networking data module 107 is used to receive a stream of social networking data. In an example embodiment, millions of new messages are delivered to social networking data module 107 each day, and in real-time. The social networking data received by the social networking data module 107 is stored in the data store 116.

The indexer module 108 performs an indexer process on the data in the data store 116 and stores the indexed data in the index store 117. In an example embodiment, the indexed data in the index store 117 can be more easily searched, and the identifiers in the index store can be used to retrieve the actual data (e.g. full messages).

A social graph is also obtained from the social networking platform server, not shown, and is stored in the social graph database 118. The social graph, when given a user as an input to a query, can be used to return all users following the queried user.

The profile store 119 stores meta data related to user profiles. Examples of profile related meta data include the aggregate number of followers of a given user, self-disclosed personal information of the given user, location information of the given user, etc. The data in the profile store 119 can be queried.

In an example embodiment, the user account relationship module 109 can use the social graph 118 and the profile store 119 to determine which users are following a particular user. In other words, a user can be identified as “friend” or “follower”, or both, with respect to one or more other users. The module 109 may also configured to determine relationships between user accounts, including reply relationships, mention relationships, and re-post relationships.

Referring again to FIG. 3, the server 100 further comprises a community identification module 112 that is configured to identify communities (e.g. a cluster of information within a queried topic such as Topic A) within a topic network. The output from a community identification module 112 comprises a visual identification of clusters (e.g. visually coded) defined as communities of the topic network that contain common characteristics and/or are affected (e.g. influenced such as follower-followee relationships), to a higher degree by other entities (e.g. influencers, experts, high-authority users) in the same community than those in another community.

The target audience module 129 performs executable instructions for identifying a target audience.

Continuing with FIG. 3, the computing device 101 includes a communication device 122 to communicate with the server 100 via the network 102, a processor 123, a memory device 124, a display screen 125, and an Internet browser 126. In an example embodiment, the GUI provided by the server 100 is displayed by the computing device 101 through the Internet browser. In another example embodiment, where an analytics application 127 is available on the computing device 101, the GUI is displayed by the computing device through the analytics application 127. It can be appreciated that the display device 125 may be part of the computing device (e.g. as with a mobile device, a tablet, a laptop, a wearable computing device, etc.) or may be separate from the computing device (e.g. as with a desktop computer, or the like).

Although not shown, various user input devices (e.g. touch screen, roller ball, optical mouse, buttons, keyboard, microphone, etc.) can be used to facilitate interaction between the user and the computing device 101.

It will be appreciated that, in another example embodiment, the system includes multiple servers. In another example embodiment, there are multiple computing devices that communicate with the one or more servers.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the server 100 or computing device 101 or accessible or connectable thereto. Any application or module herein described may be implemented using computer readable/executable instructions that may be stored or otherwise held by such computer readable media.

Turning to FIG. 4, an example embodiment of computer executable instructions are shown for determining a target audience. The instructions include obtaining an initial group of users in a social data network. This initial group may be called the sample target users. The server then obtains the identities of friends of the users (401). In the example of Twitter, the identities are called “handles”. Heuristics may then be used to eliminate very generic friends, who are followed by almost everyone on the network (402). An example of a generic friend is Jake in the example graph of FIG. 2. From the list of all friends, the server obtains the list of top N most frequently occurring friend user accounts (e.g. the top N friend Twitter handles in the example of Twitter) (403). In a non-limiting example, N is in the range of approximately 10 to 20.

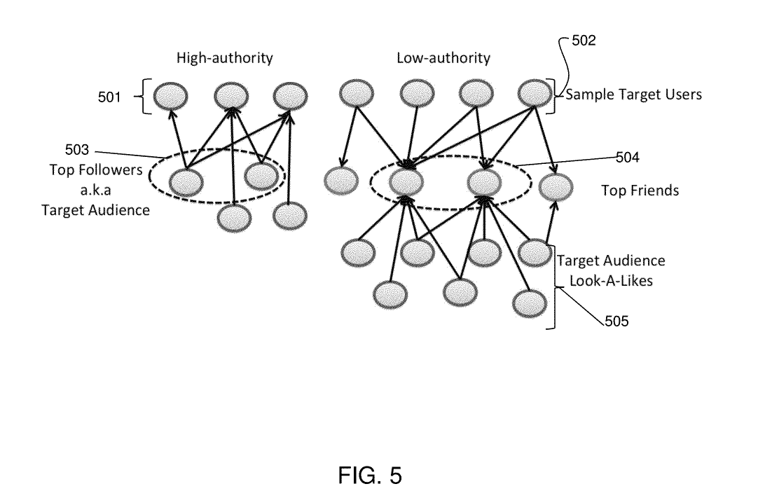

For each friend account identified in the top N, the server obtains his or her list of follower handles (see FIG. 5) (404).

The follower identities (e.g. or handles) are parsed to filter out identities that follow less than X number of top N friends (405).

The remaining list of identities (e.g. or handles) is the list of look-a-likes, also called users in the target audience (406).

Turning to FIG. 5, a set of graphs are shown for high-authority users and low-authority users. In another example, an initial group of users, or sample target users is characterized as high-authority users 501 and low-authority users 502 based on the Authority score. A threshold authority score or metric is used to separate the high-authority users from the low-authority users.

The high-authority users' relationships are analyzed to determine the top followers 503 of the high-authority users. Those top followers form part of the target audience. In an example embodiment, the top followers are those followers that are common to at least C of the high-authority users, where C is an integer ≧2. The high-authority users may also be part of the target audience.

For the low-authority users, the top friends 504 of the users are determined, and the followers 505 of those top friends are used to form part of the target audience. The top friends and the low-authority users may also be part of the target audience. It will be appreciated that the friends provide the context to identify the look-a-likes or a target-audience. In an example embodiment, the top friends are those friends that are common to at least T of the low-authority users, where T is an integer ≧2.

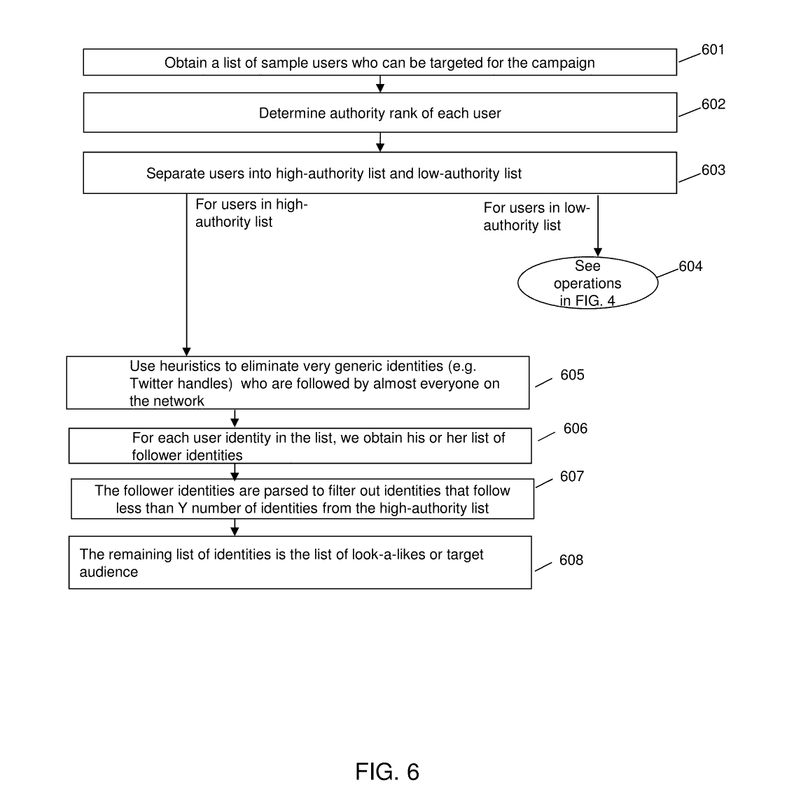

Turning to FIG. 6, example processor executable instructions are shown for identifying a target audience amongst both high-authority users and low-authority users.

Finding a target audience for a campaign (e.g. an advertising campaign) involves expanding the input list of users with large number of additional users who are similar to the input. The operations involved in generating the target audience are stated below.

The server obtains a list of sample users who can be targeted for the campaign (601). These users may be obtained from identifying influencers and their communities. The initial list of users may be obtained based on communities or groups that are related or relevant to a topic, a key word or phrase, or a brand. These users may be provided from a third-party. It is appreciated that the initial list of sample users may be obtained in various ways.

Non-limiting example embodiments of approaches for identifying an initial community or set of users are described in: U.S. Patent Application No. 61/895,539, filed Oct. 25, 2013 and titled “Systems and Methods for Determining Influencers in a Social Data Network”; U.S. Patent Application No. 61/907,878, filed Nov. 22, 2013 and titled “Systems and Methods for Identifying Influencers and Their Communities in a Social Data Network”; and U.S. Patent Application No. 62/020,833, filed Jul. 3, 2014 and titled “Systems and Methods for Dynamically Determining Influencers in a Social Data Network Using Weighted Analysis”. The contents of these patent applications are herein incorporated by reference. Other approaches of obtaining the initial list of sample users may be applied to the principles described herein.

Continuing with FIG. 6, the authority score of each user is determined (602). The users are separated into a high-authority list and a low-authority list based on their authority score (603)

For the low-authority users, the operations described in FIG. 4 are executed (604).

For the high-authority users, the server uses heuristics to eliminate very generic handles (e.g. Jake shown in FIG. 2), who are followed by almost everyone on the network (605).

For each user account identity (e.g. Twitter handle) in the list, the server obtains his or her list of follower handles (606).

The follower identities (e.g. or handles) are parsed to filter out identities that follow less than Y number of identities from the high-authority list (607), where Y is an integer.

The remaining list of identities is used to form at least part of the list of look-a-likes or the users in the target audience (608).

It is appreciated that the target audience includes the users derived from both the low-authority and the high-authority users.

After obtaining the users in the target audience, the server system sends a message, posting, or other digital content to the user accounts associated with the users in the target audience.

Example Case Studies

The underlying Twitter data is used to highlight the salient points in each of the example case studies to demonstrate the value of the proposed system and method. This section is divided into three subsections: the first section talks about the correlation between inputs and outputs (e.g. called “Interests and Demographics”); the second section talks about the usability of the lists generated (called “Match Rates”); and the third section talks about the outcomes obtained when using the expanded lists (called “Conversion Metrics”).

Interests and Demographics

When given an input list of users and asked to find look-a-likes, the first objective of course is to make sure that the input and output lists are similar in certain aspects, such as gender, geography, and in example case of Twitter, the bios that people include in their profile. This comparison provides a rough but good understanding how the inputs and outputs correlate.

The server obtains two input lists from a certain brand. In both cases the input list had 1K users. The list had a mix of influencers and other users interested in the topic. In both cases the list was expanded to 100K users. The correlation between the input and output lists is shown across 3 different dimensions.

Beauty & Grooming Example

The input and output lists had similarity in the profiles of the users. Some of the most prominent words were beauty, blogger, makeup, hair, nail, skin, skin-care, etc. As expected, the gender was biased towards females in both lists (˜60% in input list and ˜66% in output list). The brand had provided as input mainly its UK based users and so it was not surprising that the input consisted of 98% users from UK. However, the unexpected result was that in the output list ˜55% users were from UK and it was the largest contributor to the output list.

Gaming Example

This saw similar results to grooming. The input and output profiles had similar words such as xbox, videos, ps3, ps4, playstation, geek etc., (2) the gender was biased towards males in both lists (˜98% in input and ˜95% in output and (3) UK formed the largest geographic contributor to both lists (˜98% in input list and ˜59% in output list).

Although two representative examples in this section are discussed, similar or comparable trends were observed when processing other keywords related to music, “green environment,” ice-cream, social media and so on.

Match Rates

Twitter's “Tailored Audience” allows a user to upload a list of users to be targeted in a campaign. However, not all the entered users are targeted, Twitter's computing system performs some pre-processing on the list (to take into account people's privacy settings, to avoid spamming, and so on) before allowing the user to set up the campaign. After the processing, Twitter's computing system provides a number called match rate that is the percent of the input that can be targeted in the current campaign. From published match rates, the current range is anywhere from 25%-40%.

TABLE 1
Example match rates for different input list sizes

| | | | | Match |
|---|---|---|---|---|
| Upload size | Status | Size | Last updated | rate |
| 10,000 | READY | 4,640 | Jul. 30, 2014 | 45% |
| 2,000 | READY | 1,040 | Jul. 30, 2014 | 52% |
| 10,000 | READY | 5,420 | Jul. 4, 2014 | 54% |
| 10,000 | READY | 5,800 | Jul. 4, 2014 | 58% |
| 50,000 | READY | 32,585 | Jul. 31, 2014 | 65% |
| 50,000 | READY | 34,347 | Jul. 31, 2014 | 69% |
| 100,000 | READY | 66,679 | Jul. 31, 2014 | 67% |

Table 1, shows the different lists sizes generated for keywords such as “social media” and “television executives.” In most cases the Twitter match rate obtained is significantly higher than the published results. The proposed computing systems and methods described herein are able to tap into the “passive users” space. Passive users do not actively post (e.g. tweet), but they heavily use a social network (e.g. such as Twitter) as an information source of all their favorite celebrities and brands. Such users will not pop up in methods that rely on tweeting activity to identify target audience.

Conversion Metrics

In the section, two campaigns are discussed that were run using the lists generated by the proposed systems and methods described herein. In both cases the starting point was a query on a social network analytics engine, such as a Sysomos engine, to identify a few individuals related to the topic/brand. The list was then expanded using out methodology and a campaign was run using Twitter's Tailored Audience.

“Social Media” Campaign Example

Sysomos Communities (e.g. see U.S. Patent Application No. 61/907,878, filed Nov. 22, 2013 and titled “Systems and Methods for Identifying Influencers and Their Communities in a Social Data Network”) was used to identify an initial sample of 324 users who had tweeted about social media. This list was expanded to a size of 10K using the methodology. Some key points about the campaign (after 1 week of the campaign) are stated below:

The match-rate for the input list was approximately 60%.

The Engagement Rate was 3.4% in comparison to the 0.81% generated by previous campaigns using keyword searches.

Although Twitter was estimating a match rate of 6K, the campaign actually reached 14K impressions.

“Ice-cream” Brand Campaign Example

Sysomos Communities was used to identify two communities relating to “ice cream” lovers consisting of 196 users and 249 users. Each community was expanded to about 50K users using the methodology. Some key points about the campaign are stated below.

The match-rate for the input list was over 50%.

The Engagement rate was 9% and 10% for the two lists which was higher than the ˜4% generated by previous campaign runs for the same keywords.

The two campaigns reached 21 K and 27K impressions.

Note that, at this time, the brand is continuing to run the campaign owing to the strong first round results.

Based on the above, computing systems and methods are provided that identify the target audience for any campaign utilizing some sample set of users (for example, approximately 1000 users) with the required attributes and may be used to expand the set to over 100 or 1000 times its size with relevant look-a-like users. The methods use the friend relationship to understand preference and likes and exploits the network structure to identify the target audience.

These insights may be used to improve the quality and effectiveness of advertisement campaigns and may be used to narrow the gap between the intended targets and the actual targets. Furthermore, this kind of control may be used to help drive smarter and more cost-effective business decisions and improve the ROI of online campaigns.

It will be appreciated that the above systems and methods may use the graph theory to identify relationships, including the friend and follower relationships. This approach allows the relationships to be immediately, or near immediately, updated and obtained by the server. The proposed systems and methods facilitate scalability amongst more user accounts and larger social data networks. The proposed systems and methods are also less data intensive compared to continuously monitoring the data content continuously outputted by millions of users. The proposed systems and methods are also independent of a topic, because the relationships between friends are followers are not directly dependent on performing computer analysis of the content of the data posts.

Below are general example embodiments and example aspects of the systems and the methods.

In a general example embodiment, a method performed by a server system is provided for determining a target group of users in a social data network. The method includes: the server system obtaining identities of friends from a first group of users, where a user in the first group follows one or more of the friends, and the friends and the first group of users are associated with user accounts in the social data network; the server system determining N number friends that are most frequently occurring amongst the identities of friends from the first group of users; for each of the N number friends, the server system obtaining identities of followers following a given one of the N friends; the server system filtering out one or more followers from the identities of the followers that follow less than X number of the N number of friends, where X≦N; and the server system storing remaining ones of the identities of the followers as part of the target group of users in memory of the server system.

In an aspect, the method further includes, prior to the obtaining the identities of the friends from the first group of users, the server system computing an authority ranking score of each of the users in an initial group of users; the server system identifying a high-authority portion of users and a low-authority portion of users based on the authority ranks; and the server system using the low-authority portion of users as the first group of users.

In another aspect, the method further includes the server system using the high-authority portion of users as a second group of users; the server system obtaining identities of friends from the second group of users; the server system parsing out those identities of the friends from the second group of users that follow less than Y number of users from the second group of users; and the server system storing remaining ones of the identities of the friends from the second group of users as part of the target group of users in the memory.

In another aspect, the method further includes, prior to obtaining the identities of the friends from the second group of users, the server system parsing out generic users from the second group of users.

In another aspect, wherein a threshold authority ranking score separates the high-authority portion of users from the low-authority portion of users in the initial group of users.

In another aspect, the method further includes the server system identifying top followers of the high-authority portion of users; and the server system storing these top followers as part of the target group of users in the memory.

In another aspect, the top followers are those followers that are common to at least C of the high-authority portion of users, where C is an integer >2.

In another aspect, the method further includes, after identifying the target group of users, transmitting digital content to the target group of users.

In another general example embodiment, a method performed by a server system is provided for determining a target group of users in a social data network. The method includes: the server system computing an authority ranking score of each of the users in an initial group of users; the server system identifying a high-authority portion of users and a low-authority portion of users based on the authority ranking scores; the server system using the high-authority portion of users as a first group of users; the server system obtaining identities of friends from the first group of users; the server system parsing out those identities of the friends from the first group of users that follow less than Y number of users from the first group of users; and the server system storing remaining ones of the identities of the friends from the first group of users as part of the target group of users in memory of the server system.

In an aspect, the method further includes: the server system using the low-authority portion of users as a second group of users; the server system obtaining identities of friends from the second group of users, where a user in the second group follows one or more of the friends, and the friends and the first group of users are associated with user accounts in the social data network; the server system determining N number friends that are most frequently occurring amongst the identities of friends from the second group of users; for each of the N number friends, the server system obtaining identities of followers following a given one of the N friends; the server system filtering out one or more followers from the identities of the followers that follow less than X number of the N number of friends, where X≦N; and the server system storing remaining ones of the identities of the followers as part of the target group of users in memory of the server system.

In another general example embodiment, a server system is provided, which is configured to determine a target group of users in a social data network. The server system includes: one or more processors that obtain identities of friends from a first group of users, where a user in the first group follows one or more of the friends, and the friends and the first group of users are associated with user accounts in the social data network; the one or more processors determine N number friends that are most frequently occurring amongst the identities of friends from the first group of users; for each of the N number friends, the one or more processors obtain identities of followers following a given one of the N friends; the one or more processors filter out one or more followers from the identities of the followers that follow less than X number of the N number of friends, where X≦N; and a memory that stories remaining ones of the identities of the followers as part of the target group of users.

In an aspect of the server system, prior to the obtaining the identities of the friends from the first group of users, the one or more processors are configured to at least: compute an authority ranking score of each of the users in an initial group of users; the identify a high-authority portion of users and a low-authority portion of users based on the authority ranks; and use the low-authority portion of users as the first group of users.

In another aspect of the server system, the one or more processors are configured to at least: use the high-authority portion of users as a second group of users; obtain identities of friends from the second group of users; parse out those identities of the friends from the second group of users that follow less than Y number of users from the second group of users; and the server system storing remaining ones of the identities of the friends from the second group of users as part of the target group of users in the memory.

In another aspect of the server system, prior to obtaining the identities of the friends from the second group of users, the one or more processors are configured to at least parse out generic users from the second group of users.

In another aspect of the server system, a threshold authority ranking score separates the high-authority portion of users from the low-authority portion of users in the initial group of users.

In another aspect of the server system, the one or more processors are further configured to at least identify top followers of the high-authority portion of users, and store these top followers as part of the target group of users in the memory.

In another aspect of the server system, the top followers are those followers that are common to at least C of the high-authority portion of users, where C is an integer >2.

In another aspect, the server system further includes a communication device to configured to transmit digital content to the target group of users.

In another aspect, the server system further includes a communication device, wherein the one or more processors and the communication device are used to obtain the identities of the friends from the first group of users, and are used to obtain the identities of the followers following a given one of the N friends.

In another general example embodiment, a server system is provided, which is configured to determine a target group of users in a social data network. The server system includes one or more processors that are configured to at least: compute an authority ranking score of each of the users in an initial group of users; identify a high-authority portion of users and a low-authority portion of users based on the authority ranking scores; use the high-authority portion of users as a first group of users; and obtain identities of friends from the first group of users; parse out those identities of the friends from the first group of users that follow less than Y number of users from the first group of users. The server system also includes a memory configured to store remaining ones of the identities of the friends from the first group of users as part of the target group of users.

The steps or operations in the flow diagrams described herein are just for example. There may be many variations to these steps or operations without departing from the spirit of the invention or inventions. For instance, the steps may be performed in a differing order, or steps may be added, deleted, or modified.

The GUIs and screen shots described herein are just for example. There may be variations to the graphical and interactive elements without departing from the spirit of the invention or inventions. For example, such elements can be positioned in different places, or added, deleted, or modified.

It will also be understood that, other example embodiments encompassed herein include different aspects of different example embodiments described herein that are combined together, although these combinations are not explicitly stated.

Although the above has been described with reference to certain specific embodiments, various modifications thereof will be apparent to those skilled in the art without departing from the scope of the claims appended hereto.

What is claimed:

1. A method performed by a server system for determining a target group of users in a social data network, the method comprising:
the server system obtaining identities of friends from a first group of users, where a user in the first group follows one or more of the friends, and the friends and the first group of users are associated with user accounts in the social data network;
the server system determining N number friends that are most frequently occurring amongst the identities of friends from the first group of users;
for each of the N number friends, the server system obtaining identities of followers following a given one of the N friends;
the server system filtering out one or more followers from the identities of the followers that follow less than X number of the N number of friends, where X≦N; and
the server system storing remaining ones of the identities of the followers as part of the target group of users in memory of the server system.

2. The method of claim 1 further comprising, prior to the obtaining the identities of the friends from the first group of users, the server system computing an authority ranking score of each of the users in an initial group of users; the server system identifying a high-authority portion of users and a low-authority portion of users based on the authority ranks; and the server system using the low-authority portion of users as the first group of users.

3. The method of claim 2 further comprising the server system using the high-authority portion of users as a second group of users; the server system obtaining identities of friends from the second group of users; the server system parsing out those identities of the friends from the second group of users that follow less than Y number of users from the second group of users; and the server system storing remaining ones of the identities of the friends from the second group of users as part of the target group of users in the memory.

4. The method of claim 3 further comprising, prior to obtaining the identities of the friends from the second group of users, the server system parsing out generic users from the second group of users.

5. The method of claim 2 wherein a threshold authority ranking score separates the high-authority portion of users from the low-authority portion of users in the initial group of users.

6. The method of claim 2 further comprising the server system identifying top followers of the high-authority portion of users; and the server system storing these top followers as part of the target group of users in the memory.

7. The method of claim 6 wherein the top followers are those followers that are common to at least C of the high-authority portion of users, where C is an integer ≧2.

8. The method of claim 1 further comprising, after identifying the target group of users, transmitting digital content to the target group of users.

9. A method performed by a server system for determining a target group of users in a social data network, the method comprising:
the server system computing an authority ranking score of each of the users in an initial group of users;
the server system identifying a high-authority portion of users and a low-authority portion of users based on the authority ranking scores;
the server system using the high-authority portion of users as a first group of users;
the server system obtaining identities of friends from the first group of users;
the server system parsing out those identities of the friends from the first group of users that follow less than Y number of users from the first group of users; and
the server system storing remaining ones of the identities of the friends from the first group of users as part of the target group of users in memory of the server system.

10. The method of claim 9 further comprising the server system using the low-authority portion of users as a second group of users; the server system obtaining identities of friends from the second group of users, where a user in the second group follows one or more of the friends, and the friends and the first group of users are associated with user accounts in the social data network; the server system determining N number friends that are most frequently occurring amongst the identities of friends from the second group of users; for each of the N number friends, the server system obtaining identities of followers following a given one of the N friends; the server system filtering out one or more followers from the identities of the followers that follow less than X number of the N number of friends, where X≦N; and the server system storing remaining ones of the identities of the followers as part of the target group of users in memory of the server system.

11. A server system configured to determine a target group of users in a social data network, the server system comprising:
one or more processors that obtain identities of friends from a first group of users, where a user in the first group follows one or more of the friends, and the friends and the first group of users are associated with user accounts in the social data network;
the one or more processors determine N number friends that are most frequently occurring amongst the identities of friends from the first group of users;
for each of the N number friends, the one or more processors obtain identities of followers following a given one of the N friends;
the one or more processors filter out one or more followers from the identities of the followers that follow less than X number of the N number of friends, where X≦N; and
a memory that stores remaining ones of the identities of the followers as part of the target group of users.

12. The server system of claim 11 wherein, prior to the obtaining the identities of the friends from the first group of users, the one or more processors are configured to at least: compute an authority ranking score of each of the users in an initial group of users; the identify a high-authority portion of users and a low-authority portion of users based on the authority ranks; and use the low-authority portion of users as the first group of users.

13. The server system of claim 12 wherein the one or more processors are configured to at least: use the high-authority portion of users as a second group of users; obtain identities of friends from the second group of users; parse out those identities of the friends from the second group of users that follow less than Y number of users from the second group of users; and the server system storing remaining ones of the identities of the friends from the second group of users as part of the target group of users in the memory.

14. The server system of claim 13 wherein, prior to obtaining the identities of the friends from the second group of users, the one or more processors are configured to at least parse out generic users from the second group of users.

15. The server system of claim 12 wherein a threshold authority ranking score separates the high-authority portion of users from the low-authority portion of users in the initial group of users.

16. The server system of claim 12 wherein the one or more processors are further configured to at least identify top followers of the high-authority portion of users, and store these top followers as part of the target group of users in the memory.

17. The server system of claim 16 wherein the top followers are those followers that are common to at least C of the high-authority portion of users, where C is an integer ≧2.

18. The server system of claim 11 further comprising a communication device to configured to transmit digital content to the target group of users.

19. The server system of claim 11 further comprising a communication device, wherein the one or more processors and the communication device are used to obtain the identities of the friends from the first group of users, and are used to obtain the identities of the followers following a given one of the N friends.
